(19) United States
(12) Patent Application Publication
(10) Pub. No.: US 2026/0208136 A1
(43) Pub. Date: Jul. 23, 2026

(54) MULTIPLE-BED CATALYTIC REACTOR COMPRISING A DISTRIBUTION DEVICE

(71) Applicant: Topsoe A/S, Kgs. Lyngby (DK)

(72) Inventors: Rasmus Asker Calundann, Holte (DK); Anders Lul Paridon Sørensen, Copenhagen NV (DK); Louise Jivan Shan, Vedbæk (DK); Olav Holm-Christensen, Fredensborg (DK)

(73) Assignee: Topsoe A/S, Kgs. Lyngby (DK)

(21) Appl. No.: 19/137,865

(22) PCT Filed: Dec. 11, 2023
(86) PCT No.: PCT/EP2023/085105

§ 371 Date: Jun. 11, 2025

(30) Foreign Application Priority Data
Dec. 13, 2022 (EP) 22213013.0

(51) Int. Cl. B01J 8/04; C10G 49/00

(52) U.S. Cl. CPC B01J 8/0453; B01J 8/0492; B01J 8/0496; C10G 49/002; B01J 2208/00318; B01J 2208/00849; B01J 2208/00893; B01J 2208/00938

(57) ABSTRACT

The present invention relates to multi-bed catalytic reactor with a cylindrical shape comprising a distribution device further comprising a feed distributor which is separate from a recycle fluid distributor and thus protects the feed against the higher recycle fluid temperatures.

### FIELD OF THE INVENTION

This invention relates to a reactor comprising a distribution device, specifically a multi-bed renewables hydroprocessing reactor. Specifically, the distribution device is for use in down-flow catalytic reactors which include vertically superimposed packed beds of particulate catalytic material wherein a fluid: liquid, liquid and gas mixture or vapour is processed as it flows down through the packed beds. This type of reactor is used in the petroleum and chemical processing industries for carrying out various catalytic reactions, such as sulphur and nitrogen conversion (HDS/HDN); hydrogenation of: olefins (HYD) and aromatics (hydrodearomatisation—HDA), metals removal (hydrodemetallisation—HDM), oxygen conversion (hydrodeoxygenation—HDO) and hydrocracking (HC), specifically this invention addresses problems which especially arises in renewables hydroprocessing.

### BACKGROUND OF THE INVENTION

Hydroprocessing is taking place in a hydroprocessing catalytic reactor which is the key element of a hydroprocessing unit. Hydroprocessing catalytic reactors can have single or multiple catalyst beds. Which of the options will be chosen for a particular reactor depends on the amount of catalyst is required for conversion of the feed to the product with desired properties. Most of the hydroprocessing reactions are exothermic and heat is developed as feed is passing through the catalyst bed. In order not to expose the catalyst to higher temperatures than required, and consequently to accelerate deactivation of the catalyst, the required volume of catalyst is divided into a number of beds with cooling zones (quench sections) installed between the beds. Traditionally the cooling is achieved by introduction of cold hydrogen gas through the “quench pipe”. Besides the cooling, the quench zone must achieve spatial uniformity of species/temperatures of the liquid phase leaving the section to the lower bed. For this purpose, a mixing chamber is installed in the section.

After the cooling and mixing stage the fluid must be distributed evenly on the catalyst of the bed below. For this purpose, distribution trays are installed below the mixing chamber and above the catalyst of the lower bed. In order to achieve the highest distribution quality, it must be assured that the distributor trays operate within own sensitivity limits. One parameter which improves the operation of distributor trays is that the liquid depth difference on the tray from end to end of the “tray” is minimized. Therefore, flow parameters of the fluid exiting the mixing chamber are often changed by different means and brought to the values required for the best performance of the distributor tray.

In renewables hydroprocessing there is a larger risk of fouling than in traditional hydroprocessing when there is a rise in feed temperature. Besides the above-described challenges with mixing and distribution, this introduces yet a further challenge for the distribution devices.

Known art mixers propose a solution to the problem of effective mixing and space requirements for the mixer. U.S. Pat. No. 8,017,095 discloses means to provide mixing of gas and fluids in a height constrained interbed space of a catalytic reactor without increasing pressure drop. In particular, the device improves the effectiveness of an existing mixing volume in mixing the gas phase and liquid phase of two-phase systems. According to U.S. Pat. No. 8,017,095, the mixing device helps create a highly arcuate flow to incoming effluents and a high degree of mixing within a constrained interbed space of a catalytic reactor.

Due to the installation, un-installation and maintenance requirements as well as for cleaning of all elements of the quench section it is crucial to provide enough space for full access to any of the elements. In order to minimise complexity of the work in the reactor it is necessary to enable convenient and fast opening/closing of all manways of all of the elements of the section.

US2015328610 discloses a mixing device mounted between two catalyst beds in a multi-bed catalytic reactor with a cylindrical shape. The mixing device has a circular outer rim which corresponds to the inner wall of the reactor and includes a collecting section for collecting fluid from an up-stream catalytic bed, a mixing section for mixing the collected fluid, and a discharging section for discharging the mixed fluid to a down-stream catalytic bed. The collecting section, the mixing section and the discharging section are disposed outside the centre of the circular cross-section of the reactor.

Accordingly, there is a need for an effective distribution device providing free space for cleaning and service which solves the problem of fouling of the feed due to temperature rise of the feed especially present in renewables hydroprocessing.

Therefore, a need exists to provide catalytic reactor with an improved and efficient distributor providing free space for service and cleaning and solving the problems of fouling due to elevated feed temperatures.

### SUMMARY OF THE INVENTION

The new multi-bed reactor with a cylindrical shape comprising at least one distribution device according to the invention distribute fresh feed over a catalyst bed independently of recycle oil and gas, allowing the feed to remain at low temperature during distribution, thus at a low or no risk of polymerization, coking or other means of fouling. Recycle oil and gas is homogenized independently (and each phase separately) in order to combat any maldistribution effects on temperature of composition from the previous catalytic bed. The elimination of a dedicated two-phase mixer reduces space requirements and cost. The increased free space improves accessibility for cleaning the internals.

According to this invention the distribution device comprises a novel principle of distributing the feed in separate feed distribution channels covering the entire cross section. In an embodiment, soaking gas, which enters the reactor with the feed, is used to shield the feed channel from ambient heat. Feed and soaking gas is distributed evenly over the reactor cross section using the excess pressure (for instance 1.5 bar) in the feed inlet, which gives it an extremely uniform distribution as compared to normal VLT's. Recycle oil and gas is homogenized independently (each phase separately) in order to combat any maldistribution effects on temperature of composition from the previous bed.

This has the effect that the separate feed distribution system keeps the highly reactive feed at low temperatures until it meets the catalyst bed. This reduces the risk of polymerization in the bed, and ensures that when the feed is finally heated up, is does so in a hydrogen rich environment, which also lowers the risk of polymerization.

The recycle streams in the reactor are used as dilution and as a heat sink in the embodiment. Contrary to the existing solutions the recycle gas and oil will first be mixed with the feed inside the next bed, and not inside the quench zone internals.

The new multi-bed reactor with a cylindrical shape according to the invention comprises at least one distribution device for distribution of fluids. It is to be understood that fluids means either liquid(s), gas(ses) or vapour(s) or a mixture of two or more of the mentioned. The distribution device comprises at least one recycle fluid inlet and distribution tray (the recycle fluid is a more or less processed fluid which is recycling within the reactor or derives from downstream the reactor). This recycled fluid enters the distribution tray via the recycle fluid inlet of that specific distribution tray, and the distribution tray then passes the recycle fluid throughout the distribution tray to distribute the recycle fluid evenly over the area of a catalytic bed below the distribution device. How well and even the distribution tray is able to distribute the recycle fluid depends on several factors, such as number of distribution points, pressure loss over the distribution device, how level the distribution tray is among other. According to the invention, the distribution device further comprises a separate feed distributor. The separate feed distributor comprises at least one feed inlet and a plurality of feed outlets. It may be sufficient with one feed inlet as long as the feed inlet has the necessary capacity for the fluid flow, however a plurality of feed outlets are necessary to ensure an even distribution of feed over the catalytic bed below as will also be discussed later on. The feed distributor has means to distribute the feed fluid from the at least one feed inlet to the plurality of feed outlets. This may be done by any means known in the art such as pipes or channels connecting the one or more feed inlet and manifolding out to the plurality of feed outlets. The feed distributor is separated from fluid connection to the mentioned recycle fluid within the distribution device, i.e. within the distribution device, the feed fluid does not come into contact with the recycle fluid. This is important to gain the effect that the feed fluid is protected against the higher temperatures of the recycle fluid in a time before the feed fluid contacts the catalytic bed which is long enough to risk polymerisation and fouling as mentioned in the description earlier.

The described distribution device may in some cases be located in the top of the catalytic reactor, entirely above the catalytic bed or beds of the reactor, ensuring distribution of recycle fluid and ensuring safe (with regard to potential overheating) distribution of feed over the catalytic bed below the distribution device. In an embodiment of the invention, the described distribution device is mounted between two catalyst beds in the reactor. In this case, the distribution device further comprises a collection tray which is adapted to collect fluid coming down from the catalytic bed above the distribution device. To enable the collected fluid to pass to the distribution tray, the collection tray comprises at least one recycle fluid inlet. In an embodiment, the collection tray may comprise an at least partially fluid tight plate which is mounted level above the distribution tray and the recycle fluid inlet may be at least one hole or drain in the collection tray.

In an embodiment of the invention, the mentioned plurality of feed outlets is adapted to distribute the feed fluid below the mentioned collection tray. Accordingly, the feed fluid is distributed below the zone where the recycle fluid is collected, thus, the discharged feed fluid is not in contact with the recycle feed in a zone where the recycle feed is collected with the temperature/time exposure this would entail. The plurality of feed outlets is in a further embodiment adapted to distribute the feed over at least 90% of the entire cross section of catalytic bed located below the distribution device and said plurality of feed outlets. The ability for the feed outlets to distribute the feed evenly over as large a part of the below catalytic bed is dependent on several factors such as number and pattern of feed outlets, outlet design, feed pressure, distance from feed outlets to the below bed, cross-sectional area of the bed to mention some. Regarding the present invention comprising the at least one distribution device, especially the number and pattern of the feed outlets are to be considered. It is to be understood that the plurality of feed outlets may also distribute the feed to almost 100% of the entire cross section of the catalytic bed located below the distribution device or to a lesser part of the cross-sectional area, such as more than 80% or more than 60% of the entire cross section of the catalytic bed below the distribution device.

To fluidly connect the at least one feed inlet to the plurality of feed outlets, the feed distributor may in a further embodiment comprise feed channels. It is to be understood that fluidly connect means that a connection is provided which allows fluid (a gas, liquid or vapour) to flow from the at least one feed inlet to the plurality of feed outlets. In a further embodiment of the invention, the distribution device comprises cooling channels which are adapted to protect the feed fluid from ambient temperatures. This may be accomplished in different ways; the cooling channels may be in any kind of contact with the feed channels which allows for a cooling fluid to cool down the feed. In an embodiment of the invention, each feed channel is at least partly surrounded by at least one of the cooling channels. This may be the case in a smaller or larger part of the length of the feed channels, as well as in intermittent parts of the length of the feed channels. Also, each feed outlet may be at least partly surrounded by a cooling channel or a cooling channel outlet, thereby even cooling the feed when it exits the feed outlet(s), which has the effect that the feed is protected against degrading temperatures and fouling.

In an embodiment of the invention, the feed distributor further comprises a feed phase separator to separate a liquid feed phase from a gas feed phase of the feed fluid. The feed phase separator may be located between said at least one feed inlet and the plurality of feed outlets, and the separated gas feed phase may have a fluid connection from a feed gas phase outlet of the feed phase separator to at least one of the cooling channels, thus, the gas phase of the feed may be utilized to cool and/or protect the liquid phase of the feed while the liquid phase of the feed is flowing in at least a part of the feed distributor, as the liquid phase of the feed which has the risk of fouling. (It is to be understood that a separate cooling fluid, for instance a cooling gas may also be added from outside the reactor to cool and/or protect the liquid phase of the feed.) In a further embodiment of the invention, the feed distributor also comprises a cooling fluid inlet adapted to provide a cooling fluid to the feed distributor, as it may be necessary or beneficial to ensure cooling of the feed also by an extra cooling fluid, which may flow in the above described cooling means.

In an embodiment of the invention, the at least one recycle fluid inlet may comprise both a recycle gas inlet and separate from this a recycle liquid inlet if beneficial. In an embodiment of the invention, the recycle gas may by-pass the distribution device via a recycle gas mixer and a recycle gas by-pass channel, while the recycle liquid flowing from the recycle liquid inlet in a further embodiment flows through a recycle liquid mixer and a recycle liquid distributor which is adapted to distribute the recycle liquid from the collection tray and the recycle liquid mixer onto the distribution tray, from where it is to be further distributed onto the below catalytic bed. This may in an embodiment be accomplished by means of some further recycle liquid fine distributors which are in liquid connection to the recycle liquid mixer and are adapted to distribute the recycle liquid from the distribution tray onto the catalytic bed below as described above. These recycle liquid fine distributors may in an embodiment be of a chimney type as can be further seen and described in the drawings.

In an embodiment of the invention, the recycle gas by-pass channel will by-pass the recycle gas from the collection tray to exit below the distribution tray, thus, the recycle gas will not contribute notably to a temperature increase within the distribution device. In another embodiment of the invention, the recycle gas by-pass channel is adapted to by-pass the recycle gas from the collection tray to the distribution tray and further to said recycle liquid fine distributors, where it may have the effect of enhancing the liquid fine distribution.

In an embodiment of the invention a method of distributing a process fluid and a feed fluid inside a multi-bed catalytic reactor with a cylindrical shape is provided. The process fluid comprises a gas phase and a liquid phase and possibly also a vapour phase. The feed fluid is mixed with the process fluid between an upper catalyst bed and a lower catalyst bed of the multi-bed catalytic reactor, or entirely above a catalyst bed of the multi-bed catalytic reactor. The method of distributing is performed in a distribution device comprising a collection tray with at least one recycle fluid inlet; a distribution tray adapted to distribute recycle fluid and located below the collection tray; and a separate feed distributor comprising at least one feed inlet and a plurality of feed outlets. A specific feature of the invention is that the feed distributor is separated from fluid connection to the recycle fluid within the distribution device, which protects the feed fluid from the higher temperatures of the recycle fluid that may cause fouling of the feed fluid. The feed fluid may even be further protected or cooled when flowing inside the distribution device. The method comprises the steps of constricting the cross-sectional area of the flow of recycle fluid from the upper catalyst bed the at least one recycle fluid inlet by means of the collection tray. The collection tray may be a metal plate which blocks the entire cross-sectional area of the catalytic reactor except for flow through the at least one recycle fluid inlet which allows flow of recycle fluid through that specific point(s) of the collection tray. In a further step of the method, the recycle fluid flows within the distribution device or is partly by-passing the distribution device, as also discussed above. At least a part of the recycle fluid is then distributed onto the distribution tray and from the distribution tray over the catalytic bed located below the distribution device. As for the feed fluid, a step of the method is to provide the feed fluid from at least one feed inlet to the feed distributor. The feed distributor is separated from fluid connection to the recycle fluid within the distribution device, which protects the feed fluid from the higher temperatures of the recycle fluid within the distribution device, which could otherwise lead to fouling of the feed as also discussed in the above. In a further step of the method, the feed fluid is then distributed from the at least one feed inlet to a plurality of feed outlets, while still keeping the feed fluid separated from fluid connection to the recycle fluid.

In a further embodiment of the invention, the distributing process of fluid further comprises feed channels which connects the at least one feed inlet with the plurality of feed outlets and further comprises a step of cooling the feed fluid by a cooling fluid provided by cooling channels which are at least partly surrounding the feed channels in at least a part of their length. Separating the recycle fluid and the feed fluid within the distribution device is protecting the feed fluid from the higher temperatures of the recycle fluid, but this active cooling of the feed fluid within the distribution device even further contributes to the temperature protection of the feed fluid within the distribution device and hence contributes to the avoidance of feed fouling.

In a further embodiment of the invention, the multi-bed catalytic reactor with a cylindrical shape comprising at least one distribution device according the above described is used for renewables hydroprocessing, where the risk of fouling is particularly present.

### FEATURES OF THE INVENTION

1. A multi-bed catalytic reactor with a cylindrical shape comprising at least one distribution device, said distribution device comprises at least one recycle fluid inlet and distribution tray adapted to distribute recycle fluid, wherein said distribution device further comprises a separate feed distributor comprising at least one feed inlet and a plurality of feed outlets and adapted to distribute a feed fluid from said at least one feed inlet to said plurality of feed outlets, wherein said feed distributor is separated from fluid connection to said recycle fluid within the distribution device.
2. A multi-bed catalytic reactor with a cylindrical shape according to feature 1, wherein said distribution device is mounted between two catalyst beds in said reactor, said distribution device further comprises a collection tray comprising the at least one recycle fluid inlet, wherein the distribution tray is located below said collection tray.
3. A multi-bed catalytic reactor with a cylindrical shape comprising at least one distribution device according to feature 2, wherein said plurality of feed outlets are adapted to distribute the feed below said collection tray.
4. A multi-bed catalytic reactor with a cylindrical shape comprising at least one distribution device according to any of the preceding features, wherein said plurality of feed outlets are adapted to distribute the feed over at least 90% of the entire cross section of a catalytic bed located below the distribution device and said plurality of feed outlets.
5. A multi-bed catalytic reactor with a cylindrical shape comprising at least one distribution device according to any of the preceding features, wherein the feed distributor further comprises feed channels which fluidly connect the feed inlet with the plurality of feed outlets.
6. A multi-bed catalytic reactor with a cylindrical shape comprising at least one distribution device according to feature 5, wherein the feed distributor further comprises cooling channels adapted to protect the feed fluid from ambient temperatures.
7. A multi-bed catalytic reactor with a cylindrical shape comprising at least one distribution device according to feature 6, wherein each feed channel is at least partly surrounded by at least one of said cooling channels.
8. A multi-bed catalytic reactor with a cylindrical shape comprising at least one distribution device according to feature 6 or 7, wherein each feed outlet is at least partly surrounded by a cooling channel outlet.
9. A multi-bed catalytic reactor with a cylindrical shape comprising at least one distribution device according to any of the preceding features, wherein said feed distributor further comprises a feed phase separator located between said at least one feed inlet and said plurality of feed outlets and adapted to separate a feed liquid phase and a feed gas phase from said feed fluid.
10. A multi-bed catalytic reactor with a cylindrical shape comprising at least one distribution device according to feature 9, wherein said feed distributor further has a fluid connection from a feed gas phase outlet of the feed phase separator to said at least one of the cooling channels.
11. A multi-bed catalytic reactor with a cylindrical shape comprising at least one distribution device according to any of the preceding features, wherein said feed distributor further comprises a cooling fluid inlet adapted to provide a cooling fluid to said feed distributor.
12. A multi-bed catalytic reactor with a cylindrical shape comprising at least one distribution device according to any of the preceding features wherein the at least one recycle fluid inlet comprises a recycle gas inlet and a recycle liquid inlet.
13. A multi-bed catalytic reactor with a cylindrical shape comprising at least one distribution device according to feature 12, further comprising a recycle gas mixer and a recycle gas by-pass channel.
14. A multi-bed catalytic reactor with a cylindrical shape comprising at least one distribution device according to feature 12 or 13, further comprising a recycle liquid mixer and a recycle liquid distributor, the recycle liquid distributor is adapted to distribute the recycle liquid from the collection tray and the recycle liquid mixer onto the distribution tray.
15. A multi-bed catalytic reactor with a cylindrical shape comprising at least one distribution device according to any of the preceding features, wherein the distribution tray comprises a plurality of recycle liquid fine distributors adapted to distribute the liquid from the distribution tray onto the catalytic bed below the distribution device.
16. A multi-bed catalytic reactor with a cylindrical shape comprising at least one distribution device according to feature 15, wherein the recycle liquid fine distributors are chimney type liquid fine distributors.
17. A multi-bed catalytic reactor with a cylindrical shape comprising at least one distribution device according to any of the features 13-16, wherein said recycle gas by-pass channel is adapted to by-pass the recycle gas from the collection tray to exit below the distribution tray.
18. A multi-bed catalytic reactor with a cylindrical shape comprising at least one distribution device according to any of the features 15-16, wherein said recycle gas by-pass channel is adapted to by-pass the recycle gas from the collection tray to the distribution tray and further to said recycle liquid fine distributors.
19. A method of distributing a process fluid comprising a gas phase and a liquid phase and possibly a vapour phase, and a feed fluid inside a multi-bed catalytic reactor with a cylindrical shape between an upper catalyst bed and a lower catalyst bed thereof, said method is performed in a distribution device comprising a collection tray comprising at least one recycle fluid inlet; a distribution tray adapted to distribute recycle fluid and located below said collection tray; a separate feed distributor comprising at least one feed inlet and a plurality of feed outlets, wherein said feed distributor is separated from fluid connection to said recycle fluid within the distribution device, the method comprising the steps of,
   constricting the cross-sectional area of the flow of recycle fluid from the upper catalyst bed to the at least one recycle fluid inlet by means of the collection tray
   flowing the recycle fluid within or partly by-passing the distribution device,
   distributing at least a part of the recycle fluid on to the distribution tray and evenly distributing at least a part of the recycle fluid from the distribution tray over the catalytic bed located below the distribution device,
   providing a feed fluid from a feed inlet to the feed distributor separated from fluid connection to the recycle fluid within the distribution device,
   distributing the feed fluid from the feed inlet to a plurality of feed outlets while keeping the feed fluid separated from fluid connection to the recycle fluid.
20. A method of distributing a process fluid according to feature 19, said method further comprising feed channels which connects said feed inlet with the plurality of feed outlets and further comprising the step of cooling the feed fluid by a cooling fluid provided by cooling channels at least partly surrounding said feed channels.
21. Use of a multi-bed catalytic reactor with a cylindrical shape comprising at least one distribution device according to any of the features 1-19 for renewables hydroprocessing.

### BRIEF DESCRIPTION OF THE DRAWINGS

The invention is further illustrated by the accompanying drawings showing examples of embodiments of the invention.

FIG. 1 shows an isometric side view of the distribution device in a multi-bed catalytic reactor (not shown) according to an embodiment of the invention.

FIG. 2 shows a side view the distribution device in a multi-bed catalytic reactor (not shown) according to an embodiment of the invention.

FIG. 3 shows a side cut view the distribution device in a multi-bed catalytic reactor (not shown) according to an embodiment of the invention.

FIG. 4 shows a side cut view the distribution device in a multi-bed catalytic reactor (not shown) according to an embodiment of the invention.

FIG. 5 shows an isometric cut view of a detail of the distribution device in a multi-bed catalytic reactor (not shown) according to an embodiment of the invention.

FIG. 6 shows a side cut view of a part of the distribution device in a multi-bed catalytic reactor (not shown) according to an embodiment of the invention.

FIG. 7 shows a side cut view of a part of the distribution device in a multi-bed catalytic reactor (not shown) according to an embodiment of the invention.

Position numbers
01. Distribution device.
02. Collection tray.
03. Recycle fluid inlet.
04. Recycle gas inlet.
05. Recycle liquid inlet
06. Distribution tray.
07. Feed distributor.
08. Feed inlet.
09. Feed outlet.
10. Cooling channel.
11. Cooling channel outlet.
12. Recycle gas mixer and by-pass channel.
13. Recycle liquid mixer.
14. Recycle liquid distributor.
15. Recycle liquid fine distributor.

### DESCRIPTION OF THE DRAWINGS

A number of embodiments of the invention will be explained in more detail in the following, with reference to the drawings. It is to be understood that these drawings represent examples of embodiments of the invention but there are several other possible examples of the invention according to the claims. Hence, the drawings and the following description are examples of the invention, but not an exhaustive description of the invention according to the claims.

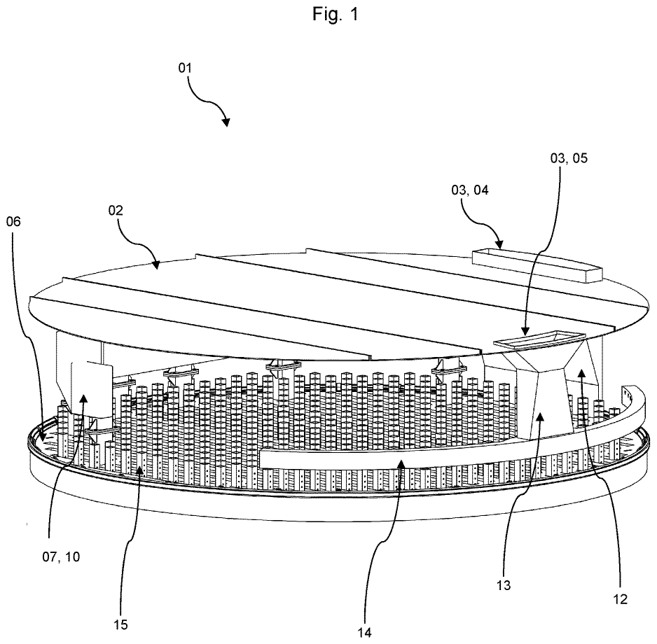

The drawing presented in FIG. 1 shows an isometric top/side view of a distribution device 01 in a multi-bed catalytic reactor (not shown) according to an embodiment of the invention. The distribution device has a circular shape to correspond the inner circular wall of the cylindrical reactor wherein the distribution device is to be installed. On the top of the distribution device, a collection tray 02 is restricting fluid flow from above the distribution device, to collect it and lead it on to the recycle fluid inlet 03, which in this embodiment shown is a dedicated recycle gas inlet 04. It is to be understood that some embodiments may have only one recycle fluid inlet, but as can be seen on FIG. 1, this embodiment has also a dedicated recycle liquid inlet 05, thus separating the recycle fluid entering above the distribution device in a liquid and a gas stream.

In this embodiment, the recycle gas stream is mixed and by-passed to below the distribution device via a recycle gas mixer and by-pass channel 12. The recycle liquid is mixed in the recycle liquid mixer 13 and led on to the recycle liquid distributor 14, to even out the delivery of the recycle liquid to the distribution tray 06 of the distribution device.

On the distribution tray, the recycle liquid spreads out over the cross-sectional area of the mixer, before the recycle liquid is passed on through the bottom of the mixer and onto a below catalytic bed (not shown) of the catalytic reactor via a plurality of recycle liquid mixer fine distributors 15.

A feed fluid is also provided to the distribution device via a feed inlet 08 (not visible on this figure) and a feed distributor 07. The feed is protected against high temperatures whilst in the feed distributor by cooling channels 10, as will be more apparent in the following.

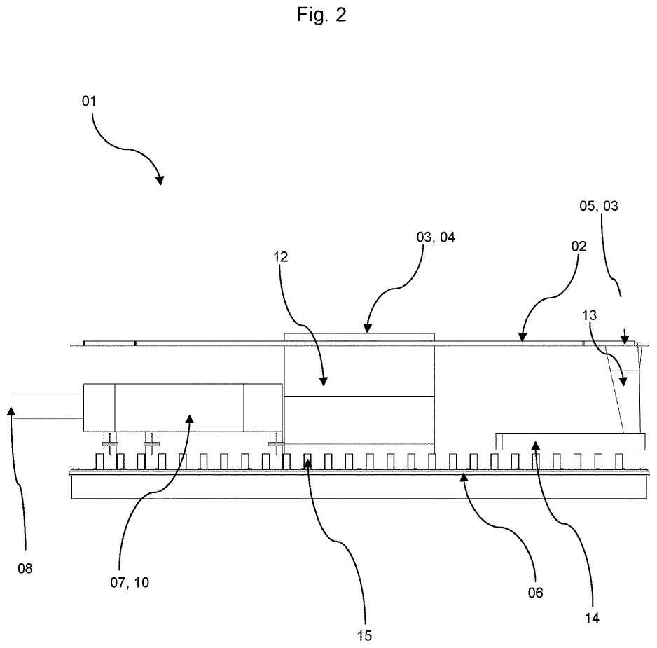

FIG. 2 shows the same embodiment of the distribution device, but from a different angle and in a side view. Here, the mentioned feed inlet 08 is visible. It can be seen how it leads into the feed distributor and further how the cooling channel encapsules the feed distributor to protect the feed fluid from high temperatures present in the distribution device to prevent fouling of the feed before it is delivered. The further features of FIG. 2 are the same as in FIG. 1 and described in the above.

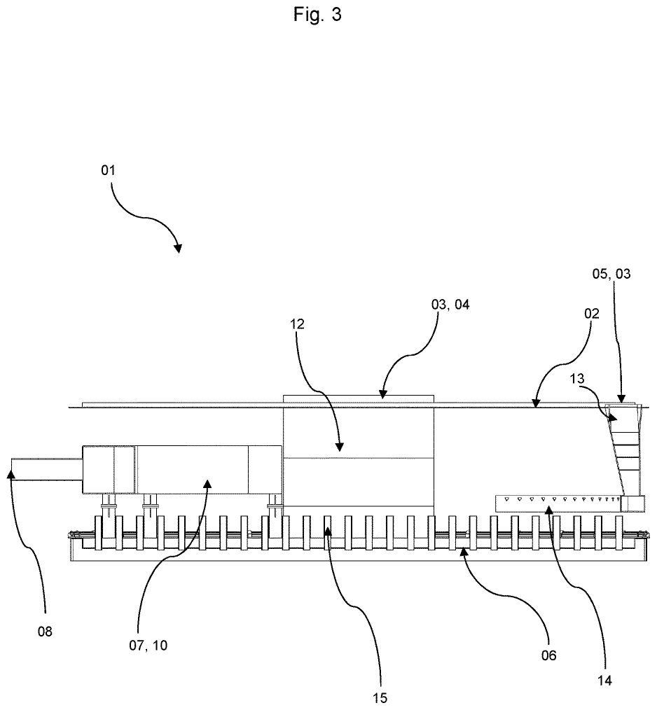

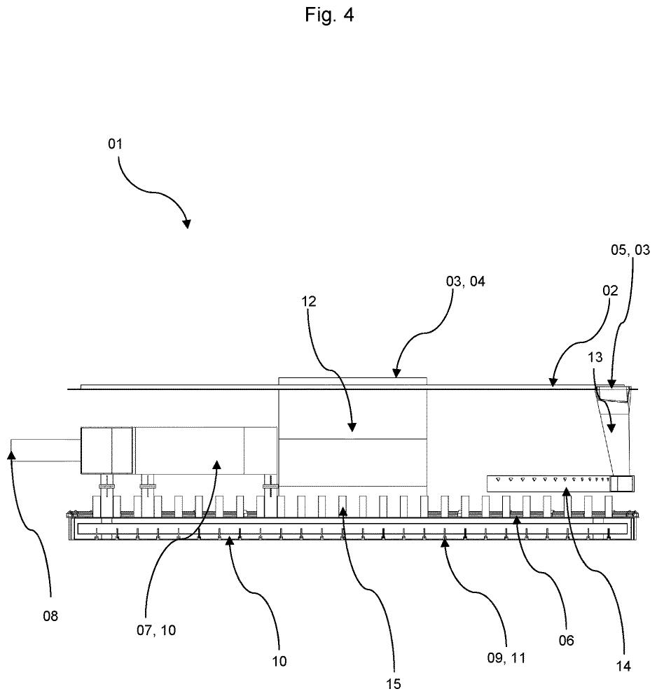

FIG. 3 and FIG. 4 shows more details seen in a cut side view of how the feed distributor passes the feed fluid down through the distribution device via a number of vertical channels and further to horizontal channels (all part of the feed distributor 07). In FIG. 4 also the final passage for the feed fluid, the feed outlets 09 become visible, as does the cooling channel outlets 11. They are shown in more detail in the following figures, but it is visible in overview in FIG. 4 how the feed fluid is delivered to the catalytic reactor near to the below catalytic bed below and how the feed fluid all the way from the feed inlet and through the distribution device is protected against high temperatures and thus fouling by the cooling channels and even by the cooling fluid surrounding the feed fluid when it exits the feed outlets.

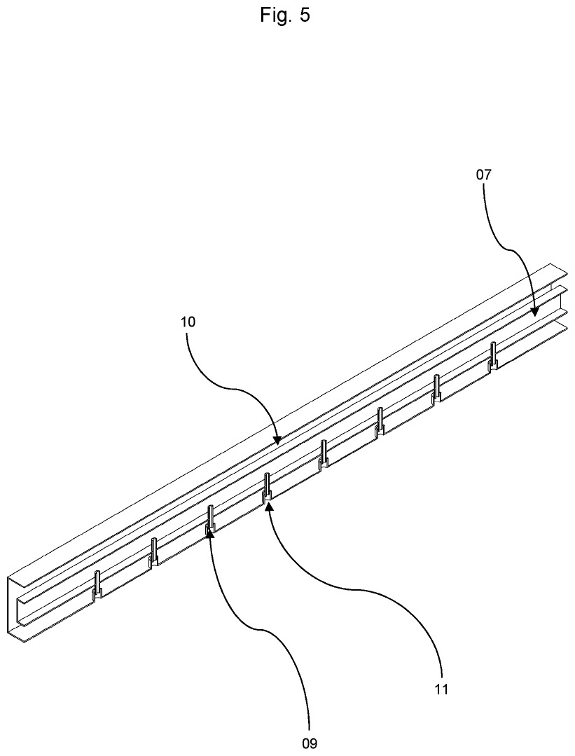

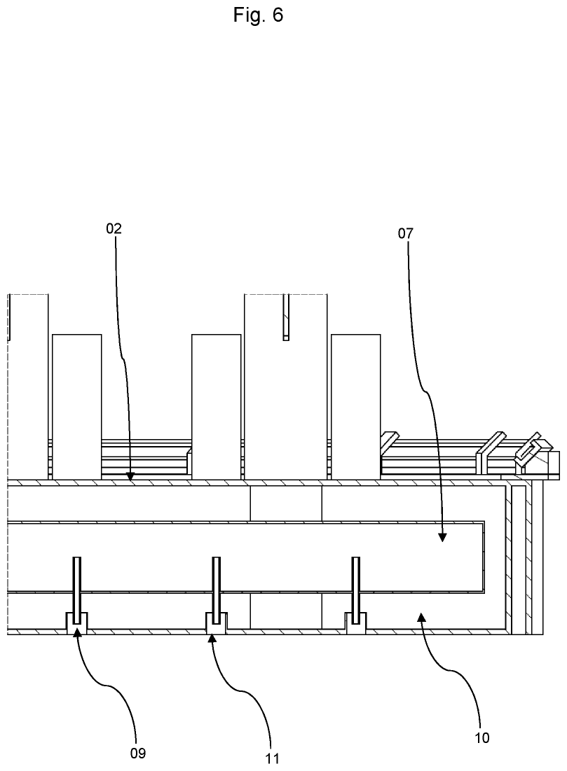

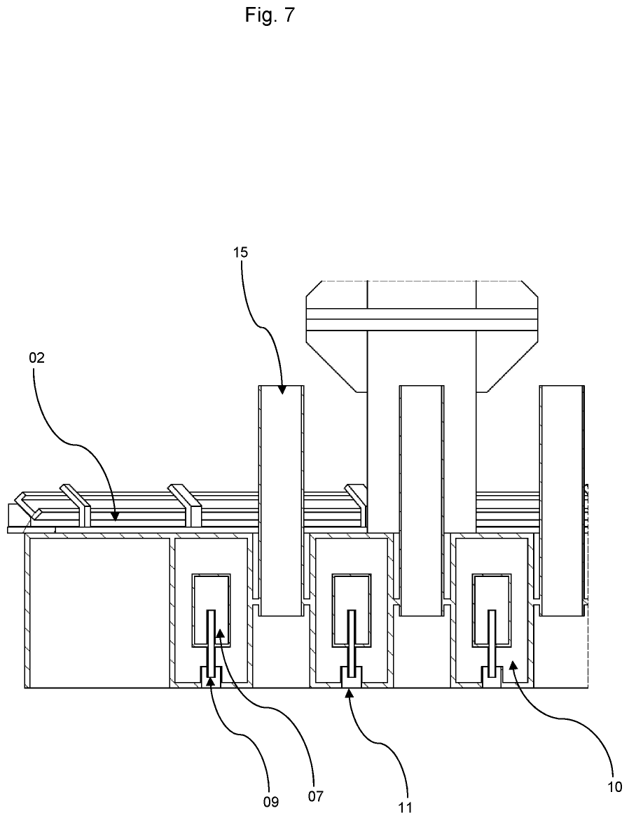

The detail view in FIG. 5 shows in much more detail how the feed outlets are connected to the feed distributor and how it is all encapsuled and protected against heat by the cooling channel, which even provides a skirt or ring of protective cooling fluid around the feed fluid when exiting through the feed outlets by means of the cooling channel outlets. This is also visible in FIG. 6 and FIG. 7, which however also shows how the above-mentioned details are incorporated into the distribution device as a whole.

1. A multi-bed catalytic reactor with a cylindrical shape comprising at least one distribution device, said distribution device comprises at least one recycle fluid inlet and distribution tray adapted to distribute recycle fluid, wherein said distribution device further comprises a separate feed distributor comprising at least one feed inlet and a plurality of feed outlets and adapted to distribute a feed fluid from said at least one feed inlet to said plurality of feed outlets, wherein said feed distributor is separated from fluid connection to said recycle fluid within the distribution device.

2. A multi-bed catalytic reactor with a cylindrical shape according to claim 1, wherein said distribution device is mounted between two catalyst beds in said reactor, said distribution device further comprises a collection tray comprising the at least one recycle fluid inlet, wherein the distribution tray is located below said collection tray.

3. A multi-bed catalytic reactor with a cylindrical shape comprising at least one distribution device according to claim 2, wherein said plurality of feed outlets are adapted to distribute the feed below said collection tray.

4. A multi-bed catalytic reactor with a cylindrical shape comprising at least one distribution device according to claim 1, wherein said plurality of feed outlets are adapted to distribute the feed over at least 90% of the entire cross section of a catalytic bed located below the distribution device and said plurality of feed outlets.

5. A multi-bed catalytic reactor with a cylindrical shape comprising at least one distribution device according to claim 1, wherein the feed distributor further comprises feed channels which fluidly connect the feed inlet with the plurality of feed outlets.

6. A multi-bed catalytic reactor with a cylindrical shape comprising at least one distribution device according to claim 5, wherein the feed distributor further comprises cooling channels adapted to protect the feed fluid from ambient temperatures.

7. A multi-bed catalytic reactor with a cylindrical shape comprising at least one distribution device according to claim 6, wherein each feed channel is at least partly surrounded by at least one of said cooling channels.

8. A multi-bed catalytic reactor with a cylindrical shape comprising at least one distribution device according to claim 6, wherein each feed outlet is at least partly surrounded by a cooling channel outlet.

9. A multi-bed catalytic reactor with a cylindrical shape comprising at least one distribution device according to claim 1, wherein said feed distributor further comprises a feed phase separator located between said at least one feed inlet and said plurality of feed outlets and adapted to separate a feed liquid phase and a feed gas phase from said feed fluid.

10. A multi-bed catalytic reactor with a cylindrical shape comprising at least one distribution device according to claim 9, wherein said feed distributor further has a fluid connection from a feed gas phase outlet of the feed phase separator to said at least one of the cooling channels.

11. A multi-bed catalytic reactor with a cylindrical shape comprising at least one distribution device according to claim 1, wherein said feed distributor further comprises a cooling fluid inlet adapted to provide a cooling fluid to said feed distributor.

12. A multi-bed catalytic reactor with a cylindrical shape comprising at least one distribution device according to claim 1, wherein the at least one recycle fluid inlet comprises a recycle gas inlet and a recycle liquid inlet.

13. A multi-bed catalytic reactor with a cylindrical shape comprising at least one distribution device according to claim 12, further comprising a recycle gas mixer and a recycle gas by-pass channel.

14. A multi-bed catalytic reactor with a cylindrical shape comprising at least one distribution device according to claim 12, further comprising a recycle liquid mixer and a recycle liquid distributor, the recycle liquid distributor is adapted to distribute the recycle liquid from the collection tray and the recycle liquid mixer onto the distribution tray.

15. A multi-bed catalytic reactor with a cylindrical shape comprising at least one distribution device according to claim 1, wherein the distribution tray comprises a plurality of recycle liquid fine distributors adapted to distribute the liquid from the distribution tray onto the catalytic bed below the distribution device.

16. A multi-bed catalytic reactor with a cylindrical shape comprising at least one distribution device according to claim 15, wherein the recycle liquid fine distributors are chimney type liquid fine distributors.

17. A multi-bed catalytic reactor with a cylindrical shape comprising at least one distribution device according to claim 13, wherein said recycle gas by-pass channel is adapted to by-pass the recycle gas from the collection tray to exit below the distribution tray.

18. A multi-bed catalytic reactor with a cylindrical shape comprising at least one distribution device according to claim 15, wherein said recycle gas by-pass channel is adapted to by-pass the recycle gas from the collection tray to the distribution tray and further to said recycle liquid fine distributors.

19. A method of distributing a process fluid comprising a gas phase and a liquid phase and possibly a vapor phase, and a feed fluid inside a multi-bed catalytic reactor with a cylindrical shape between an upper catalyst bed and a lower catalyst bed thereof, said method is performed in a distribution device comprising a collection tray comprising at least one recycle fluid inlet; a distribution tray adapted to distribute recycle fluid and located below said collection tray; a separate feed distributor comprising at least one feed inlet and a plurality of feed outlets, wherein said feed distributor is separated from fluid connection to said recycle fluid within the distribution device, the method comprising the steps of,
constricting the cross-sectional area of the flow of recycle fluid from the upper catalyst bed to the at least one recycle fluid inlet by means of the collection tray
flowing the recycle fluid within or partly by-passing the distribution device,
distributing at least a part of the recycle fluid on to the distribution tray and evenly distributing at least a part of the recycle fluid from the distribution tray over the catalytic bed located below the distribution device,
providing a feed fluid from a feed inlet to the feed distributor separated from fluid connection to the recycle fluid within the distribution device,
distributing the feed fluid from the feed inlet to a plurality of feed outlets while keeping the feed fluid separated from fluid connection to the recycle fluid.

20. A method of distributing a process fluid according to claim 19, said method further comprising feed channels which connects said feed inlet with the plurality of feed outlets and further comprising the step of cooling the feed fluid by a cooling fluid provided by cooling channels at least partly surrounding said feed channels.

21. Use of a multi-bed catalytic reactor with a cylindrical shape comprising at least one distribution device according to claim 1, for renewables hydroprocessing.
